(19) United States
(12) Patent Application Publication
(10) Pub. No.: US 2018/0315298 A1
(43) Pub. Date: Nov. 1, 2018

(54) EMERGENCY TRANSPORTATION ARRANGEMENT APPARATUS, EMERGENCY TRANSPORTATION ARRANGEMENT SYSTEM AND EMERGENCY TRANSPORTATION ARRANGEMENT METHOD

(71) Applicant: Honda Motor Co., Ltd., Tokyo (JP)

(72) Inventors: Shiro Kitamura, Wako-shi (JP); Kimiyoshi Kusaka, Wako-shi (JP); Shigenori Hiruta, Wako-shi (JP)

(21) Appl. No.: 15/960,193

(22) Filed: Apr. 23, 2018

(30) Foreign Application Priority Data
May 1, 2017 (JP) 2017-091306

(51) Int. Cl. G08B 27/00; G08B 31/00; G08B 25/10

(52) U.S. Cl. CPC G08B 27/005; G08B 25/014; G08B 25/10; G08B 31/00

(57) ABSTRACT

An emergency transportation arrangement apparatus, including a CPU and memory accepting a transportation-request from a patient requiring emergency-transportation to a medical-facility, acquiring a patient-data including a position-data of the patient, determining a destination-medical-facility to which the patient is to be emergency-transported based on the patient-data, registering multiple vehicles allowed in advance by their users to be employed as temporary-emergency-vehicles for emergency-transportation of patients to medical-facilities, acquiring a vehicle-data including a position data of the multiple vehicles, approving among the multiple vehicles a vehicle located within a predetermined range from the patient as an temporary-emergency-vehicle based on the patient-data and the vehicle-data when the transportation-request is accepted, and outputting the patient-data, a data of the destination-medical-facility, and a transport-instruction of the patient to the destination-medical-facility to a vehicle-side-device mounted in the vehicle approved as the temporary-emergency-vehicle or carried by a user of the vehicle.

### CROSS-REFERENCE TO RELATED APPLICATION

This application is based upon and claims the benefit of priority from Japanese Patent Application No. 2017-091306 filed on May 1, 2017, the content of which is incorporated herein by reference.

### BACKGROUND OF THE INVENTION

### Field of the Invention

This invention relates to an emergency transportation arrangement apparatus, emergency transportation arrangement system and emergency transportation arrangement method which arranges an ad hoc emergency vehicle for transporting a patient to a medical facility.

### Description of the Related Art

Ambulance dispatches have increased in recent years owing to a rising number of people urgently requiring transportation to medical facilities, and the resulting shortage of ambulances tends to lengthen the time needed to transport patients to a hospital or other facility. Apparatuses are known that help to deal with an ambulance or other emergency vehicle shortage in one area by calling for emergency vehicle assistance from another area (see Japanese Unexamined Patent Publication No. 2009-134490 (JP2009-134490A), for example).

However, an apparatus like that of JP2009-134490A that relies on another area for emergency vehicle assistance cannot adequately deal with the problem of vehicle shortage because the number of other-area vehicles that can directly reach the patient within a specified time is limited.

### SUMMARY OF THE INVENTION

An aspect of the present invention is an emergency transportation arrangement apparatus, including: a CPU and a memory coupled to the CPU, the CPU and the memory being configured to accept a transportation request from a patient requiring emergency transportation to a medical facility, the CPU and the memory being configured to acquire a patient data including a position data of the patient, the CPU and the memory being configured to determine a destination medical facility to which the patient is to be emergency transported based on the patient data, the CPU and the memory being configured to register multiple vehicles allowed in advance by their users to be employed as temporary emergency vehicles for emergency transportation of patients to medical facilities, the CPU and the memory being configured to acquire a vehicle data including a position data of the multiple vehicles, the CPU and the memory being configured to approve among the multiple vehicles a vehicle located within a predetermined range from the patient as an temporary emergency vehicle based on the patient data and the vehicle data when the transportation request is accepted, the CPU and the memory being configured to output the patient data, a data of the destination medical facility, and a transport instruction of the patient to the destination medical facility to a vehicle side device mounted in the vehicle approved as the temporary emergency vehicle or carried by a user of the vehicle.

Another aspect of the present invention is an emergency transportation arrangement system, including: a vehicle side device mounted in each of multiple vehicles allowed in advance by their users to be employed as temporary emergency vehicles for emergency transportation of patients to medical facilities or carried by users of the multiple vehicles; a patient side device carried by a patient; and an emergency transportation arrangement apparatus configured to be communicable with the vehicle side device and the patient side device, wherein the vehicle side device has: a vehicle position detection unit configured to detect a position of each of the multiple vehicles, the patient side device has: a transportation request instruction unit configured to instruct a transportation request of the patient to a medical facility; and a patient position detection unit configured to detect a position of the patient of whom the transportation request is instructed, and the emergency transportation arrangement apparatus comprises a CPU and a memory coupled to the CPU, the CPU and the memory being configured to accept the transportation request instructed by the transportation request instruction unit, the CPU and the memory being configured to acquire a patient data including position data of the patient detected by the patient position detection unit, the CPU and the memory being configured to determine a destination medical facility to which the patient is to be emergency transported based on the patient data, the CPU and the memory being configured to register the multiple vehicles allowed in advance by their users to be employed as the temporary emergency vehicles, the CPU and the memory being configured to acquire a vehicle data including position data of each of the multiple vehicles detected by the vehicle position detection unit, the CPU and the memory being configured to approve among the multiple vehicles a vehicle located within a predetermined range from the patient as an temporary emergency vehicle based on the patient data and the vehicle data when the transportation request is accepted, the CPU and the memory being configured to output the patient data, a data of the destination medical facility, and a transport instruction of the patient to the destination medical facility to the vehicle side device mounted in the vehicle approved as the temporary emergency vehicle or carried by a user of the vehicle.

Further aspect of the present invention is an emergency transportation arrangement method, including: accepting a transportation request from a patient requiring emergency transportation to a medical facility; acquiring a patient data including a position data of the patient; determining a destination medical facility to which the patient is to be emergency transported based on the patient data; registering multiple vehicles allowed in advance by their users to be employed as temporary emergency vehicles for emergency transportation of patients to medical facilities; acquiring a vehicle data including a position data of the multiple vehicles; approving among the multiple vehicles a vehicle located within a predetermined range from the patient as an temporary emergency vehicle based on the patient data and the vehicle data when the transportation request is accepted; and outputting the patient data, a data of the destination medical facility, and a transport instruction of the patient to the destination medical facility, to a vehicle side device mounted in the vehicle approved as the temporary emergency vehicle or carried by a user of the vehicle.

### BRIEF DESCRIPTION OF THE DRAWINGS

The objects, features, and advantages of the present invention will become clearer from the following description of embodiments in relation to the attached drawings, in which:

FIG. 1 is a diagram schematically showing an overall configuration of an emergency transportation arrangement system according to an embodiment of the present invention;

FIG. 2 is a block diagram showing a configuration overview of an on-vehicle terminal of FIG. 1;

FIG. 3 is a block diagram showing a configuration overview of an emergency transportation arrangement apparatus of FIG. 1;

FIG. 4 is a diagram for explaining an example of operation of the emergency transportation arrangement apparatus of FIG. 3; and

FIG. 5 is a flow chart showing an example of processing performed by the emergency transportation arrangement apparatus of FIG. 3.

### DETAILED DESCRIPTION OF THE INVENTION

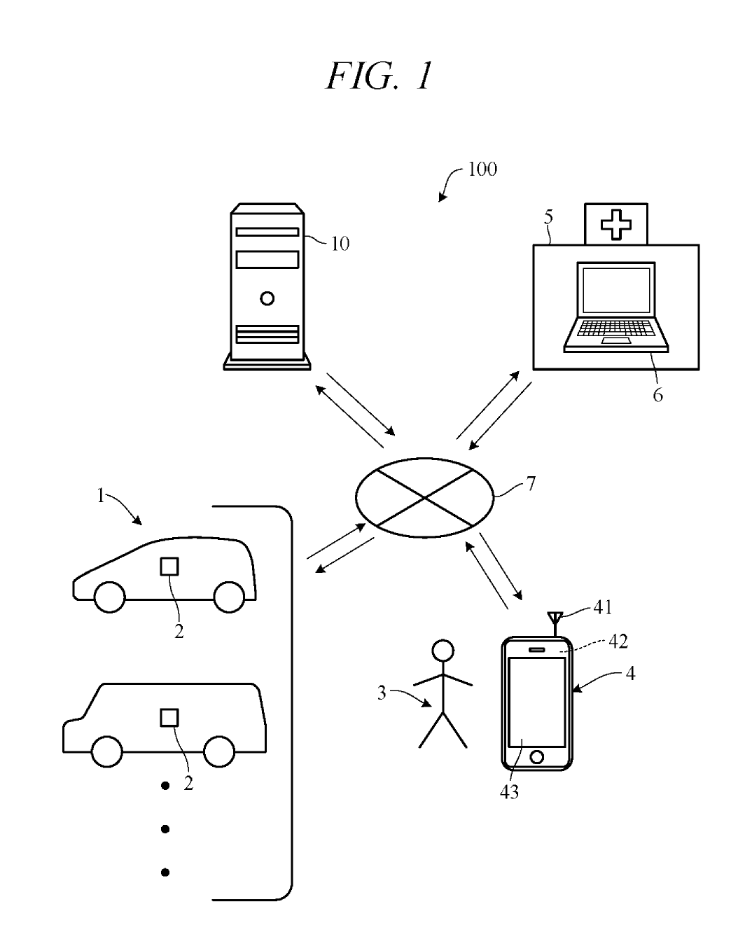

An embodiment of the present invention is explained below with reference to FIGS. 1 to 5. The emergency transportation arrangement apparatus according to this embodiment of the present invention is configured to transport a person (patient) requiring medical treatment at a medical facility such as a hospital or medical center, e.g., a person who became severely indisposed on a street or road, to a medical facility using an ordinary vehicle instead of an ambulance or other dedicated emergency vehicle. In other words, the present embodiment copes with unavailability of an ambulance or the like by using an ordinary vehicle as an ad hoc (temporary) emergency vehicle.

FIG. 1 is a diagram schematically showing the essentials of an emergency transportation arrangement system 100 according to an embodiment of the present invention. As shown in FIG. 1, the emergency transportation arrangement system 100 comprises on-vehicle terminals 2 individually mounted in multiple vehicles 1 registered beforehand as ad hoc emergency vehicles, mobile terminals 4 carried by (possible future) patients 3, hospital terminals 6 installed in hospitals or other medical facilities 5, and an emergency transportation arrangement apparatus (server) 10. The on-vehicle terminals 2, mobile terminals 4, hospital terminals 6, and emergency transportation arrangement apparatus 10 are connected to a network 7 including a wireless communications network.

The vehicles 1 are self-driving vehicles, i.e., vehicles with autonomous driving capability, and can be any of various types of four-wheel vehicles including, inter alia, sedans, minivans, one box cars, station wagons, and trucks. Among these, one box cars and station wagons are preferably used, for example, when accommodating a patient 3 in recumbent condition.

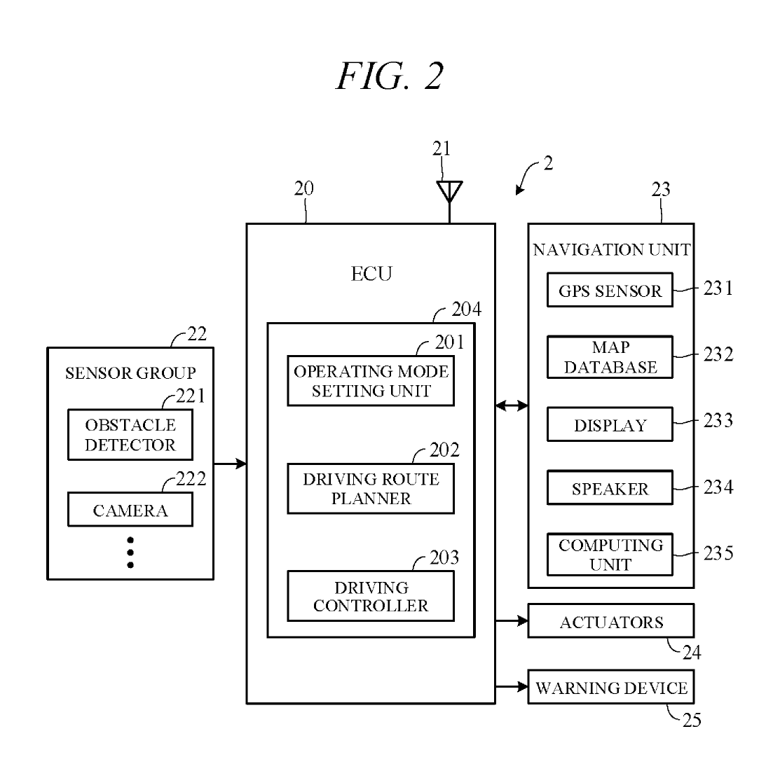

FIG. 2 is a block diagram showing a configuration overview of the on-vehicle terminal 2. As shown in FIG. 2, the on-vehicle terminal 2 comprises an ECU (electronic control unit) 20, to which are connected a wireless unit 21, a sensor group 22, a navigation unit 23, actuators 24, and a warning device 25.

The wireless unit 21 is configured to wirelessly communicate with the emergency transportation arrangement apparatus 10 (FIG. 1) through a wireless communications network, typically a mobile telephone network, wireless LAN or the like. The wireless unit 21 can be configured to include a short-range wireless communication unit (not shown) capable of utilizing a short-range wireless communication technology like Wi-Fi® or Bluetooth®. The wireless unit 21 can transmit starter switch (ignition switch) ON-OFF state data, current position data, speed data and other such information regarding the associated vehicle, i.e., associated vehicle information, to the emergency transportation arrangement apparatus 10, and can receive patient transport instructions, patient position data, medical facility position data and so on from the emergency transportation arrangement apparatus 10.

The sensor group 22 comprises multiple detection units for detecting vehicle ambient conditions, including, for example, an obstacle detector 221 and a camera 222. In addition to the detection units for detecting conditions around the vehicle, the sensor group 22 also includes various detection units for detecting data related to vehicle driving conditions, such as a vehicle speed sensor, an acceleration sensor, and a yaw rate sensor. The sensor group 22 further includes a boarding detection unit, such as a seating sensor, for detecting presence (or absence) of an onboard patient.

The navigation unit 23 comprises a GPS receiver (GPS sensor) 231 for measuring current vehicle position using signals received from GPS satellites, a map database 232 (memory unit) storing map data, a display 233 mounted in front of a driver's seat for displaying position data of the vehicle on the map, a speaker 234 for vocally informing a driver of various information, and a computing unit 235 for computing a target route. The map data stored in the map database 232 include road position, shape and other data, as well as position, footprint and other data on hospitals and various other facilities. The map data are acquired from outside (from the emergency transportation arrangement apparatus 10 etc.) through the wireless unit 21.

The computing unit 235 uses current vehicle position measured by the GPS sensor 231 and map data of the map database 232 to compute a target route from current position to a desired point (destination) and outputs target route data to the ECU 20 together with current vehicle position data. In addition, the computing unit 235 displays current vehicle position and target route on the display 233 and vocally outputs target route information from the speaker 234. Optionally, the display 233 can, for example, be configured as a touch panel that functions as an input unit for inputting various data related to route searches. Desired destinations can be input through the touch panel, and can also be acquired from the emergency transportation arrangement apparatus 10 through the wireless unit 21.

The actuators 24 are driven by control signals output from the ECU 20 so as to perform driving operations of the vehicle 1, including basic driving operations such as run, turn and stop. The actuators 24 include a driving actuator for generating vehicle propulsion power, a braking actuator for generating braking force, and a steering actuator for generating steering force. When the vehicle is an electric vehicle or a hybrid vehicle, the driving actuator consists of, for example, a propulsion motor. When the vehicle is an engine-driven vehicle, the driving actuator consists of, for example, a throttle actuator that controls throttle opening angle. The braking actuator consists of, for example, a hydraulic unit that supplies hydraulic pressure to brake disks. The steering actuator consists of, for example, a steering motor that controls steering torque of an electric power steering system.

The warning device 25 is for alerting those in the vicinity that the vehicle is an ad hoc emergency vehicle and corresponds to the siren or rotating beacon of an ambulance. The warning device 25 can consist of, for example, a warning sound-making device (car horn), light(s), blinker(s), or any of various other devices capable of alerting those in the vicinity to the status (nature) of the vehicle.

The ECU 20 is configured to include a computer having a CPU or other computing unit 204, memory unit (ROM, RAM and/or similar), and other associated peripheral circuitry. As functional constituents, the ECU 20 (primarily the CPU 204) comprises an operating mode setting unit 201, a driving route planner 202, and a driving controller 203.

The operating mode setting unit 201 sets either a manual driving mode or an autonomous driving mode in response to operation of a selector switch (not shown) operated by the driver. Manual driving mode is a mode in which the driver operates an accelerator pedal, brake pedal, steering wheel and so on, and the actuators 24 are driven to drive the vehicle in accordance with the driver's operations. Autonomous driving mode is a mode in which the ECU 20 (driving controller 203) automatically outputs control signals to the actuators 24 based on signals from, inter alia, the sensor group 22, and the vehicle 1 is autonomously driven toward the desired destination. The autonomous driving mode is divided into a manned autonomous driving mode with a driver on board and an unmanned autonomous driving mode with no driver on board.

When autonomous driving mode is selected, the driving route planner 202 creates a driving plan including a target route to the desired destination acquired by the navigation unit 23. The target route can also be acquired from the emergency transportation arrangement apparatus 10 through the wireless unit 21. The driving plan includes data on desired driving speed, desired driving acceleration and the like, in addition to the target route. Up to patient boarding being detected by the sensor group 22, the driving route planner 202 creates a driving plan to the position of the patient as the desired destination. Once patient boarding is detected, the driving route planner 202 creates a driving plan to a designated medical facility as the desired destination.

The driving controller 203 drives the vehicle by outputting control signals to the actuators 24 in a way matched to the driving mode. When in autonomous driving mode, for example, the driving controller 203 automatically drives the vehicle along the target route toward the desired destination by outputting control signals to the actuators 24 based on the driving plan created by the driving route planner 202. And it concurrently uses signals from the sensor group 22 to ascertain whether obstacles are present around the vehicle and controls driving operations by outputting control signals to the actuators 24 so as to avoid hitting any obstacles present. In manual driving mode, the vehicle is manually driven by outputting control signals to the actuators 24 based on driving commands detected by the sensor group 22 (accelerator pedal sensor, brake pedal sensor, and other operation detection units).

Although not illustrated, an arrangement can be adopted whereby the ECU 20 responds to an instruction received through the wireless unit 21 by automatically outputting a control signal to a vehicle starter switch (e.g., an ignition switch) that turns the starter switch ON and starts the vehicle. In addition, after vehicle starting, the driving controller 203 can output control signals to the actuators 24 to drive the vehicle without a driver, i.e., drive the vehicle in unmanned autonomous driving mode. When the vehicle is driven as an ad hoc emergency vehicle, the warning device 25 is operated by control signals output from the driving controller 203.

The mobile terminal 4 shown in FIG. 1 can be of any type carriable by a patient 3 and capable of connecting to a public wireless communications network through a wireless unit 41, such as a smartphone or tablet terminal, a mobile phone, or any of various kinds of wearable terminals. The mobile terminal 4 has a GPS receiver (GPS sensor) 42 that can obtain patient current position data. The mobile terminal 4 additionally has an input member 43 for requesting transportation to a medical facility. The input member 43 is a push-operated physical switch or the like. When the input member 43 is operated, an ID identifying the patient 3, a transportation request, and patient (mobile terminal 4) position data obtained from the GPS sensor 42 are transmitted through the wireless unit 41 to the emergency transportation arrangement apparatus 10.

Upon receiving a transportation request and patient position data from the patient 3, the emergency transportation arrangement apparatus 10 selects an appropriate medical facility 5 from among multiple medical facilities 5 based on patient 3 data including patient position data and transmits a patient 3 admission request to a terminal (hospital terminal 6) of the selected medical facility 5. The hospital terminal 6 determines based on the transmitted patient data whether the patient 3 can be admitted, and when admission of the patient 3 is determined to be possible, accepts a reservation for the patient 3 and transmits the determination result to the emergency transportation arrangement apparatus 10. When, to the contrary, the hospital terminal 6 determines that patient admission is impossible, this determination result is transmitted to the emergency transportation arrangement apparatus 10. Upon receiving the admission impossible determination result from the hospital terminal 6, the emergency transportation arrangement apparatus 10 selects another medical facility and transmits the same admission request to the hospital terminal of the newly selected medical facility 5.

The emergency transportation arrangement apparatus 10 is a server incorporating various functions. Although the emergency transportation arrangement apparatus 10 is treated as a single server in the following explanation, it can instead be implemented as a distributed server composed of function-specific individual servers or as a distributed type server (including a virtual server) called a cloud server.

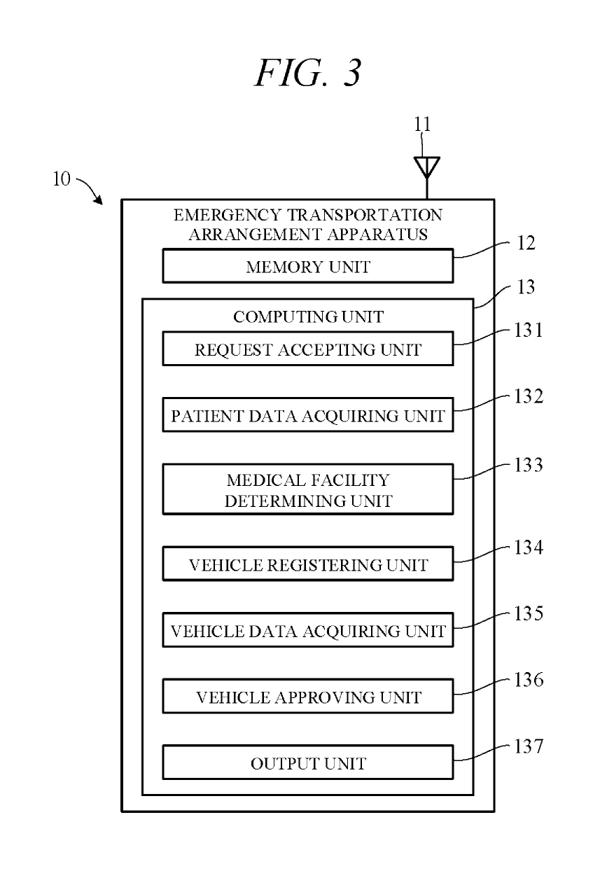

FIG. 3 is a block diagram showing a configuration overview of the emergency transportation arrangement apparatus 10. The emergency transportation arrangement apparatus 10 is configured to include a computer having a CPU or other computing unit 13, memory unit (ROM, RAM and/or similar) 12, and other associated peripheral circuitry and to be capable of communicating through a wireless unit 11 with the on-vehicle terminals 2, mobile terminals 4 and hospital terminals 6. As shown in FIG. 3, the emergency transportation arrangement apparatus 10 comprises, as functional constituents of the CPU 13, a request accepting unit 131, a patient data acquiring unit 132, a medical facility determining unit 133, a vehicle registering unit 134, a vehicle data acquiring unit 135, a vehicle approving unit 136, and an output unit 137.

The memory unit 12 is configured as a data base for storing patient ID-specific data including age, sex, medical history and other patient-specific data (patient data), addresses, service hours, closed days, medical departments, and other data of medical facilities able to accept emergency admissions, and map data such as medical facility vicinity road maps and medical facility parking lot information.

The request accepting unit 131 communicates with the mobile terminals 4 to receive transportation requests input by (or on behalf of) patients using the input member 43 of the patient's mobile terminals 4, i.e., it accepts a transportation request from any patient requiring emergency transportation to a medical facility.

The patient data acquiring unit 132 communicates with the mobile terminal 4 to acquire the ID of the patient concerned and the patient's (mobile terminal's) position data detected by the GPS sensor 231.

The medical facility determining unit 133 communicates with the hospital terminals 6 and, based on the patient's ID and position data acquired by the patient data acquiring unit 132 and the patient data and medical facility data stored in advance in the memory unit 12, determines a medical facility to which the patient should be emergency transported. When, for example, a number of emergency transportation destinations compatible with the patient data are available, the medical facility determining unit 133 selects the medical facility closest to the patient and transmits a patient admission request to the hospital terminal 6 of the selected medical facility. When the medical facility determining unit 133 receives a patient admission possible determination result from the hospital terminal 6 in reply to the admission request, it determines that medical facility as the emergency transportation destination facility. When the medical facility determining unit 133 receives an admission impossible determination result, it transmits an admission request to another medical facility and thereafter repeats the aforesaid procedure until an emergency transportation destination facility is determined.

The vehicle registering unit 134 is for registering multiple vehicles allowed in advance by their users to be employed as ad hoc emergency vehicles for emergency transportation of patients to designated medical facilities. The vehicles are registered in association with vehicle data. The vehicles are, for example, ones capable of autonomous (self) driving, and the vehicle data include vehicle user data such as user name, address and contact information, along with additional data for discriminating the vehicle by type (sedan, one box, etc.). Optionally, non-self-driving vehicles can also be registered.

The vehicle data acquiring unit 135 responds to a transportation request being accepted by the request accepting unit 131 by outputting a position data transmission instruction to the on-vehicle terminals 2 of the vehicles registered in the vehicle registering unit 134. The on-vehicle terminals 2 that receive the position data transmission instruction transmit the vehicle position data detected by their GPS sensors 231. The vehicle data acquiring unit 135 therefore acquires position data of the vehicles registered in the vehicle registering unit 134 by communicating with their on-vehicle terminals 2.

The vehicle approving unit 136 uses the patient position data (part of the patient data) acquired by the patient data acquiring unit 132 and the vehicle position data (part of the vehicle data) acquired by the vehicle data acquiring unit 135 to run a search for vehicles among the multiple vehicles registered in the vehicle registering unit 134 that are positioned within a first predefined distance from the patient.

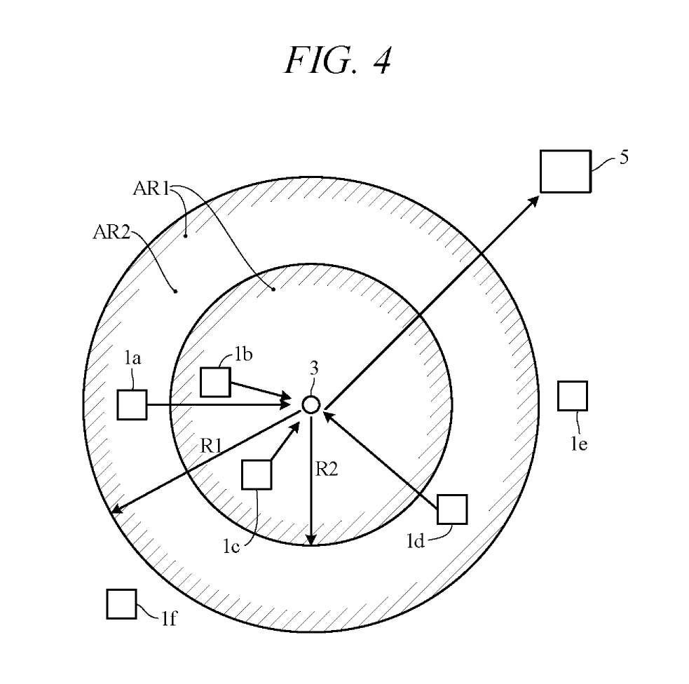

FIG. 4 is a diagram showing a patient 3, vehicles 1 (1a to 1f) around the patient 3, and an example of a medical facility 5 location. As illustrated in FIG. 4, a first predefined range AR1 is, for example, defined to extend within a radius of a first predefined distance R1 from the patient 3 at the center. Alternatively, the first predefined range AR1 can be defined taking traffic congestion and the like into account so as to ensure arrival at the position of the patient 3 within a designated time. In the example of FIG. 4, vehicles 1a to 1d are present in the first predefined range AR1. The vehicle approving unit 136 identifies the vehicles 1a to 1d and approves these vehicles as ad hoc emergency vehicles.

The output unit 137 (FIG. 3) uses the wireless unit 11 to output (transmit) to the on-vehicle terminal(s) 2 of one or more of the vehicles approved as ad hoc emergency vehicles by the vehicle approving unit 136 patient position data acquired by the patient data acquiring unit 132, position data of the medical facility determined by the medical facility determining unit 133, and a transport instruction instructing transportation of the patient to that medical facility. The transport instruction includes an instruction to drive the vehicle to the patient and an instruction to drive the car carrying the patient to the medical facility. Optionally, the emergency transportation arrangement apparatus 10 can be configured to set the target routes to the desired destinations and output (transmit) the target routes through the output unit 137 to the on-vehicle terminal(s) 2.

Now, as indicated in FIG. 4, let us set a second predefined distance R2 shorter than the first predefined distance R1 and define a range within the first predefined range AR1 lying beyond the second predefined distance R2 from the patient 3 as a second predefined range AR2. The output unit 137 uses road data stored in the memory unit 12 to compute target routes from the vehicles 1a and 1d positioned in the second predefined range AR2 to the patient 3 and outputs them to the vehicles 1a and 1d along with related route data. Optionally, computation of target routes and output of route data to the vehicles 1a to 1d can always be performed without taking distance from the car to the patient into consideration. In addition, the output unit 137 computes target routes from the position of the patient to the medical facility that is the transportation destination and outputs them to the vehicles 1a to 1d along with related route data.

The output unit 137 can also output signals to a traffic system including a traffic control unit for switching traffic signals. Specifically, the output unit 137 outputs to the traffic system position data of a vehicle approved as an ad hoc emergency vehicle by the vehicle approving unit 136 and route data from the vehicle concerned to the medical facility determined by the medical facility determining unit 133 as the patient transport destination. Upon receiving these data signals, the traffic system controls traffic signal switching in accordance with the data so as to shorten the vehicle's traffic signal wait time, whereby the vehicle can more quickly reach the medical facility. Optionally, route data between the vehicle and patient can also be output to the traffic system so that the traffic system can shorten traffic signal wait time of the vehicle by controlling traffic signal switching based on these route data and thereby enable the vehicle to quickly reach the patient.

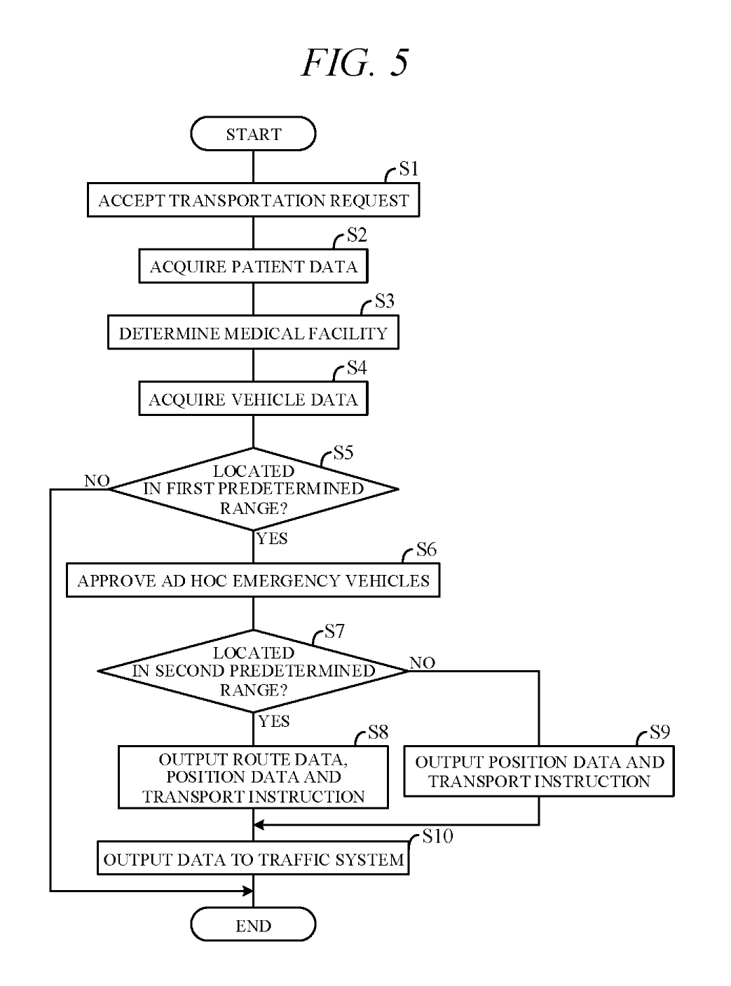

FIG. 5 is a flowchart showing an example of processing performed by the CPU of the emergency transportation arrangement apparatus 10 in accordance with a program loaded in memory beforehand. The processing shown in this flowchart is started, for example, when the emergency transportation arrangement apparatus 10 receives a transportation request output from one of the mobile terminals 4. First, in S1 (S: processing Step), the request accepting unit 131 accepts the received transportation request. Next, in S2, the patient data acquiring unit 132 acquires patient data including the patient's ID and patient position data detected by the GPS sensor 42.

Next, in S3, the medical facility determining unit 133 uses the patient data corresponding to the patient's ID, the patient position data and medical facility data to determine a medical facility that can promptly admit the patient. Next, in S4, the vehicle data acquiring unit 135 acquires vehicle data including vehicle position data detected by the GPS sensor 231. Next, in S5, the vehicle approving unit 136 determines whether vehicles registered in the vehicle registering unit 134 are located in the first predefined range AR1. When the result in S5 is YES, the program goes to S6, and when NO, processing is terminated. In S6, the vehicles determined to be located in the first predefined range AR1 are approved as ad hoc emergency vehicles.

Next, in S7, the vehicle approving unit 136 further determines whether any vehicle determined to be located in the first predefined range AR1 is located in the second predefined range AR2. When the result in S7 is YES, the program goes to S8, in which a target route from the vehicle to the patient is computed by processing in the output unit 137, and the patient position data, route data and medical facility position data are output to the vehicle in the second predefined range AR2 along with a transport instruction to transport the patient to the medical facility, On the other hand, when the result in S7 is NO, the program goes to S9, in which the patient position data, the medical facility position data, and a transport instruction are output to the vehicles in the first predefined range AR1 inside of the second predetermined range AR2. Alternatively, the medical facility position data can be output to a vehicle after the patient has boarded the vehicle rather than while the vehicle is driving to the patient as its desired destination. Optionally, it is possible in S8 and S9 to compute the target routes from the vehicles to the medical facility and output the medical facility route data together with the medical facility position data.

Next, in S10, the output unit 137 outputs to the traffic system the vehicle data acquired by the vehicle data acquiring unit 135 and the route data of the route from the vehicle having these vehicle data to the medical facility that is the patient transport destination. When multiple vehicles are approved as ad hoc emergency vehicles, only the vehicle data (vehicle position data) of the vehicle boarded by the patient is output as vehicle data after the patient boards the vehicle. Namely, once the patient boards a vehicle, only that vehicle's position data are output to the traffic system because only that vehicle operates as an ad hoc emergency vehicle on its way to the medical facility.

The operation of the emergency transportation arrangement system 100 according to the present embodiment can be summarized as follows. In the summary that follows, a case in which vehicles are driven in unmanned autonomous driving mode is exemplified. For example, in a situation such as shown FIG. 4, when the patient 3 surrounded by the vehicles 1a to 1f registered in the vehicle registering unit 134 operates the input member 43 of his or her mobile terminal 4 and causes the mobile terminal 4 to output a transportation request, the emergency transportation arrangement apparatus 10 accepts the transportation request and uses patient data including patient position data to determine the medical facility 5 as the transport destination for the patient 3 (S1 to S3).

The emergency transportation arrangement apparatus 10 additionally acquires the position data of the vehicles 1a to 1f registered beforehand in the vehicle registering unit 134, determines whether any of the vehicles 1a to 1f are located in the first predefined range AR1 centered on the patient, and approves the vehicles 1a to 1d located in the first predefined range AR1 as ad hoc emergency vehicle (S4 to S6).

As a result, transport instructions ordering that the patient 3 be transported to the medical facility 5 are output to the on-vehicle terminals 2 of the ad hoc emergency vehicles 1a to 1d (S8 and S9). In response, the on-vehicle terminals 2 create driving plans whose desired destination is the patient 3, and the vehicles 1a to 1d autonomously drive to the desired destination, as indicated by arrows in FIG. 4, while operating their warning devices 25. At this time, route data to the patient 3 are concurrently output to the vehicles 1a and 1d in the second predefined range AR2 more distant from the patient 3 (S8). So the on-vehicle terminals 2 can easily create accurate driving plans to the desired destination even when distant from the desired destination.

The multiple vehicles 1a to 1d approach the patient 3 while operating their warning devices 25 and stop nearby. The patient 3 can therefore easily recognize the vehicles 1a to 1d. When the patient 3 boards one of the multiple vehicles (e.g., the vehicle 1d), the vehicle 1d that the patient is detected to have boarded is thereafter treated as the only ad hoc emergency vehicle. Boarding of the patient can be detected, for example, by a signal from the seating sensor (sensor group 22). Patient boarding can also be detected by determining whether difference between position of the vehicle and position of the patient detected by the GPS sensors 42 and 231 is within a predetermined value.

The on-vehicle terminal 2 of the vehicle 1d carrying the patient creates a driving plan with the medical facility 5 as the desired destination and controls driving operations of the vehicle 1d by outputting control signals to the actuators 24 in accordance with the driving plan. The on-vehicle terminal 2 also outputs a control signal to the warning device 25. The vehicle 1d therefore autonomously drives to the medical facility 5, as indicated by an arrow in FIG. 4, while operating the warning device 25. At this time, the position data of the vehicle 1d and the route data of the route from the vehicle 1d to the medical facility 5 are output to the traffic system (S10), and the traffic system controls traffic signal switching in accordance with these output signals. The vehicle 1d can therefore reach the medical facility 5 in a short time.

The present embodiment can achieve advantages and effects such as the following:

(1) The emergency transportation arrangement apparatus 10 comprises: the request accepting unit 131 for accepting a transportation request from a patient requiring emergency transportation to a medical facility; the patient data acquiring unit 132 for acquiring patient data including position data of a patient whose transportation request was accepted by the request accepting unit 131; the medical facility determining unit 133 for determining based on patient data acquired from the patient data acquiring unit 132 a medical facility to which the patient is to be emergency transported; the vehicle registering unit 134 for registering multiple vehicles allowed in advance by their users to be employed as ad hoc emergency vehicles for emergency transportation of patients to medical facilities; the vehicle data acquiring unit 135 for acquiring vehicle data including position data of the multiple vehicles registered in the vehicle registering unit 134; the vehicle approving unit 136 responsive to acceptance of the transportation request by the request accepting unit 131 for, based on patient position data acquired by the patient data acquiring unit 132 and vehicle position data acquired by the vehicle data acquiring unit 135, approving as ad hoc emergency vehicles those vehicles 1a to 1d that, among the multiple vehicles 1a to 1f registered in the vehicle registering unit 134, are located within a first predefined range AR1 from the patient; and the output unit 137 for outputting to the on-vehicle terminals 2 mounted in the vehicles 1a to 1d approved as ad hoc emergency vehicles by the vehicle approving unit 136 patient position data acquired by the patient data acquiring unit 132, data of the medical facility determined by the medical facility determining unit 133, and a transport instruction instructing transportation of the patient to that medical facility (FIGS. 3 and 4).

This enables ordinary vehicles registered beforehand in the vehicle registering unit 134 to be used as ad hoc emergency vehicles for transporting patients to medical facilities. Shortages of ambulances and other emergency vehicles can therefore be thoroughly dealt with. Moreover, since vehicles located within a predefined distance from the patient are used as the ad hoc emergency vehicles in this case, the ad hoc emergency vehicles can directly reach the patient in a short time, and transport time between output of the transportation request from the mobile terminal 4 and arrival of the patient at the medical facility can be shortened.

(2) When a vehicle approved by the vehicle approving unit 136 is a predefined distance R2 or farther from the patient (vehicles 1a and 1d in FIG. 4), route data of routes from the vehicles 1a and 1d to the patient are concurrently output (S8). Since the vehicles concerned create driving plans in accordance with the related route data and drive autonomously at this time, even ad hoc emergency vehicles distant from the patient can accurately drive along their routes and quickly reach the patient.

(3) When multiple vehicles are located in the first predefined range AR1 centered on the patient (vehicles 1a to 1d in FIG. 4), the vehicle approving unit 136 approves these multiple vehicles 1a to 1d as ad hoc emergency vehicles (S6). The output unit 137 outputs patient data and transport instructions to the on-vehicle terminals 2 mounted in the multiple vehicles 1a to 1d approved as ad hoc emergency vehicles by the vehicle approving unit 136 (S8). The output of transport instructions to the multiple vehicles 1a to 1d in this manner helps the patient to easily recognize the ad hoc emergency vehicles.

(4) In addition, the output unit 137 outputs to the traffic system including the traffic control unit for switching traffic signals the vehicle data acquired by the vehicle data acquiring unit 135 and the route data of the route from the vehicle having these vehicle data to the medical facility determined by the medical facility determining unit 133 (S10). As a result, the traffic system can control traffic signal switching so as to shorten the vehicle's traffic signal wait time, whereby the vehicle can efficiently and promptly reach the medical facility.

(5) The emergency transportation arrangement system 100 comprises: the on-vehicle terminals 2 mounted in multiple vehicles 1a to 1f allowed in advance by their users to be employed as ad hoc emergency vehicles for emergency transportation of patients to medical facilities; the mobile terminals 4 carried by patients; and the aforesaid emergency transportation arrangement apparatus 10 able to communicate with the on-vehicle terminals 2 and mobile terminals 4. The on-vehicle terminal 2 has the GPS sensor 231 for detecting position of the vehicle 1, and the mobile terminal 4 has the input member 43 for inputting a patient request for transportation to a medical facility and the GPS sensor 42 for detecting position of the patient who input the transportation request (FIGS. 1 and 2). Owing to the configuration of the emergency transportation arrangement system 100 by the on-vehicle terminals 2, the mobile terminals 4 and the emergency transportation arrangement apparatus 10 in this manner, transport time of the patient can be shortened because all that is needed to arrange for ad hoc emergency vehicles to drive directly to the patient and transport the patient to a medical facility is for the patient to operate the input member 43 of the mobile terminal 4.

(6) The on-vehicle terminal 2 additionally has the sensor group 22 for detecting whether the patient boarded the associated vehicle, and the vehicle data acquiring unit 135 additionally acquires data regarding whether the patient boarded any of the multiple vehicles. Up to detection of patient boarding by a sensor group 22, the output unit 137 outputs to the traffic system vehicle data of the vehicles approved as ad hoc emergency vehicles and route data of the route from the vehicles having such vehicle data via the patient to a medical facility, and after patient boarding is detected, outputs to the traffic system vehicle data of that vehicle among the approved ad hoc emergency vehicles that the patient boarded and route data of the route from the vehicle having such vehicle data to a medical facility. As a result, the traffic system can control traffic signal switching so as to shorten traffic signal wait time of only the vehicle the patient actually boarded, and thereby minimize the effect on traffic conditions.

(7) The on-vehicle terminal 2 additionally has the warning device 25 that can alert those in the vicinity to the vehicle's emergency vehicle status. The multiple vehicles 1a to 1d can therefore approach the patient 3 while operating their warning devices 25 and stop nearby, whereby the patient 3 can easily be made aware of the vehicles 1a to 1d.

(8) The warning device 25 can consist of a warning sound-making device (car horn), light(s) or blinker(s). In other words, any of various alarms, lamps and similar installable in ordinary vehicles can be adopted as the warning device 25, so that a user owned vehicle can be registered as an ad hoc emergency vehicle without adding any special warning equipment to the vehicle.

(9) The method of arranging emergency transportation comprises: accepting a transportation request from a patient requiring emergency transportation to a medical facility (S1); acquiring patient data including position data of the patient whose transportation request was accepted (S2); determining a medical facility to which the patient is to be emergency transported based on the acquired patient data (S3); registering multiple vehicles allowed in advance by their users to be employed as ad hoc emergency vehicles for emergency transportation of patients to medical facilities and acquiring vehicle data including position data of the registered multiple vehicles (S4); responding to acceptance of a transportation request by, based on acquired patient data and acquired vehicle data, approving as ad hoc emergency vehicles those vehicles among the multiple registered vehicles that are located within a predefined range AR1 from the patient (S6); and outputting to on-vehicle terminals 2 mounted in the vehicles approved as ad hoc emergency vehicles patient position data, data of a medical facility, and a transport instruction instructing transportation of the patient to the medical facility (S5). Since this enables ordinary vehicles to be used as ad hoc emergency vehicles for transporting patients to medical facilities, shortages of ambulances and other dedicated emergency vehicles can be dealt with.

Various modifications of the aforesaid embodiment are possible. Some examples are explained in the following. In the aforesaid embodiment, ad hoc emergency vehicles that receive a patient transport instruction autonomously drive directly to the patient, but the ad hoc emergency vehicles can instead stand by in parking lots or the like until the patient boards, and a driving plan be created whose desired destination of the ad hoc emergency vehicle is solely the medical facility. Although the patient him- or herself has to search for a nearby ad hoc emergency vehicle in this case, it easy for the patient find an ad hoc emergency vehicle provided that the ad hoc emergency vehicles operate their warning devices 25 while standing by in the parking lots.

The embodiment explained in the foregoing relates to an example in which the emergency transportation arrangement apparatus 10, method of arranging emergency transportation, and emergency transportation arrangement system 100 are applied to vehicles that drive in unmanned autonomous driving mode, but they can also be similarly applied to vehicles that drive in manned autonomous driving mode or manual driving mode. For example, they can be simultaneously applied to both vehicles that drive in autonomous driving mode and vehicles that drive in manual driving mode. When a vehicle approved as an ad hoc emergency vehicle drives in unmanned autonomous driving mode, its data is preferably transmitted to the vehicle user's mobile terminal.

When the emergency transportation arrangement apparatus 10, method of arranging emergency transportation, and emergency transportation arrangement system 100 are applied to vehicles that drive in manual driving mode, a configuration can be adopted in which, for example, the output unit 137 transmits transportation requests to mobile terminals or the like carried by the users of vehicles approved as ad hoc emergency vehicles by the vehicle approving unit 136 and transmits patient position data, medical facility position data and the like to the on-vehicle terminals 2 of the vehicles concerned, and the destinations are set in the navigation units 23 of the vehicles or in the vehicle user mobile terminals based on these position data. Since this enables a vehicle user to recognize presence/absence of a request for emergency transport even when at home or when driving the vehicle, for example, the vehicle user can manually drive the vehicle to the patient and transport the patient to a medical facility. In manned autonomous driving mode and in manual driving mode, the vehicle user is riding in the vehicle and can therefore help the patient board the user's own vehicle approved as an ad hoc emergency vehicle.

Thus the vehicle side device to which the output unit outputs transport instructions etc. is not limited to the on-vehicle terminal 2 mounted in the ad hoc emergency vehicle but can instead be a smart phone or other mobile terminal carried by the vehicle user. In other words, the configuration of the vehicle position detection unit is not limited to that described in the foregoing, and the position of the vehicle can instead be detected by a GPS sensor or the like of a mobile terminal carried by the vehicle user rather than by the GPS sensor 231 of the on-vehicle terminal 2.

In the aforesaid embodiment, vehicles registered beforehand in the vehicle registering unit 134 and located within the first predefined range AR1 from the patient are approved as ad hoc emergency vehicles, but it is alternatively possible to detect a vehicle condition using the sensor group 22 and perform ad hoc emergency vehicle approval in accordance with not only vehicle position but also a vehicle condition. In the case of a vehicle that drives in autonomous driving mode, for example, that vehicle is in unstarted condition owing to its ignition switch being OFF, for instance, can be made a condition for ad hoc emergency vehicle approval. On the other hand, in the case of a vehicle that drives in manual driving mode, the fact that the ignition switch is ON means that the vehicle can immediately drive directly to the patient, so that the ignition switch is ON can be made a condition for ad hoc emergency vehicle approval.

In the aforesaid embodiment, a transportation request is initiated by operating the input member 43 of the mobile terminal 4, but an arrangement can also be adopted that automatically initiates a transportation request instruction, independently of input member 43 operation, when a sensor or sensors provided to measure patient physical condition(s) (e.g., body temperature, blood pressure, heart rate, pulse, brainwaves) indicate certain health problems. One particular possibility is to install a sensor or sensors that can measure patient level of consciousness (LOC) and automatically initiate a transportation request when LOC measured by the sensor(s) is at or below a predetermined value. The configuration of the transportation request initiation unit is therefore not limited to that of the input member 43. In the case of detecting LOC, the type(s) of vehicle approved as ad hoc emergency vehicles can optionally be varied according to detected LOC. Namely, a configuration can be adopted whereby the vehicle approving unit 136 responds to detection of low LOC, i.e., when recumbent transport of the patient is preferable, by approving one box cars, station wagons and similar as ad hoc emergency vehicles. Optionally, the medical facility determining unit can determine the medical facility to be transportation destination based on patient physical condition measured by the sensor(s).

In the aforesaid embodiment, the GPS sensor 42 detects the position of the patient carrying the mobile terminal 4, but the patient position detection unit is not limited to this configuration. Specifically, the patient side device can be of any configuration insofar as it comprises a transportation request initiation unit for initiating requests for transportation of the patient to a medical facility and a patient position detection unit for detecting position of the patient who initiated the transportation request. In the aforesaid embodiment, multiple vehicles are approved as ad hoc emergency vehicles when multiple vehicles registered beforehand in the vehicle registering unit 134 are located within the first predefined range AR1 from the patient, but it is alternatively possible to approve only a single vehicle, such as the vehicle that can reach the patient quickest, as an ad hoc emergency vehicle. Namely, the vehicle approving unit is not limited to the aforesaid configuration insofar as it approves an ad hoc emergency vehicle(s) based on at least vehicle position data and patient position data.

The above embodiment can be combined as desired with one or more of the above modifications. The modifications can also be combined with one another.

According to the present invention, since at least one ad hoc emergency vehicle is approved from among ordinary vehicles registered in advance taking patient position and the like into account and an instruction to transport the patient to a medical facility is output to the ad hoc emergency vehicle(s), it offers a strong countermeasure against emergency vehicle shortages.

Above, while the present invention has been described with reference to the preferred embodiments thereof, it will be understood, by those skilled in the art, that various changes and modifications may be made thereto without departing from the scope of the appended claims.

What is claimed is:

1. An emergency transportation arrangement apparatus, comprising:
a CPU and a memory coupled to the CPU,
the CPU and the memory being configured to accept a transportation request from a patient requiring emergency transportation to a medical facility,
the CPU and the memory being configured to acquire a patient data including a position data of the patient,
the CPU and the memory being configured to determine a destination medical facility to which the patient is to be emergency transported based on the patient data,
the CPU and the memory being configured to register multiple vehicles allowed in advance by their users to be employed as temporary emergency vehicles for emergency transportation of patients to medical facilities,
the CPU and the memory being configured to acquire a vehicle data including a position data of the multiple vehicles,
the CPU and the memory being configured to approve among the multiple vehicles a vehicle located within a predetermined range from the patient as an temporary emergency vehicle based on the patient data and the vehicle data when the transportation request is accepted,
the CPU and the memory being configured to output the patient data, a data of the destination medical facility, and a transport instruction of the patient to the destination medical facility to a vehicle side device mounted in the vehicle approved as the temporary emergency vehicle or carried by a user of the vehicle.

2. The emergency transportation arrangement apparatus according to claim 1, wherein
the CPU and the memory are configured to additionally output a route data from the vehicle approved as the temporary emergency vehicle to the patient when the vehicle is separated from the patient by a predetermined distance.

3. The emergency transportation arrangement apparatus according to claim 1, wherein
the CPU and the memory are configured to, when a plurality of the vehicle is located within the predetermined range from the patient, approve each of the plurality of the vehicle as the temporary emergency vehicle, and
the CPU and the memory are configured to output the patient data and the transport instruction to the vehicle side device mounted in each of the plurality of the vehicle approved as the temporary emergency vehicle or carried by the user of each of the plurality of the vehicle.

4. The emergency transportation arrangement apparatus according to claim 1, wherein
the CPU and the memory are configured to output the vehicle data and a route data from a vehicle having the vehicle data to the destination medical facility to a traffic system including a traffic control unit for switching traffic signals.

5. An emergency transportation arrangement system, comprising:
a vehicle side device mounted in each of multiple vehicles allowed in advance by their users to be employed as temporary emergency vehicles for emergency transportation of patients to medical facilities or carried by users of the multiple vehicles;
a patient side device carried by a patient; and
an emergency transportation arrangement apparatus configured to be communicable with the vehicle side device and the patient side device, wherein
the vehicle side device has:
a vehicle position detection unit configured to detect a position of each of the multiple vehicles,
the patient side device has:
a transportation request instruction unit configured to instruct a transportation request of the patient to a medical facility; and
a patient position detection unit configured to detect a position of the patient of whom the transportation request is instructed, and
the emergency transportation arrangement apparatus comprises a CPU and a memory coupled to the CPU,
the CPU and the memory being configured to accept the transportation request instructed by the transportation request instruction unit,
the CPU and the memory being configured to acquire a patient data including position data of the patient detected by the patient position detection unit,
the CPU and the memory being configured to determine a destination medical facility to which the patient is to be emergency transported based on the patient data,
the CPU and the memory being configured to register the multiple vehicles allowed in advance by their users to be employed as the temporary emergency vehicles,
the CPU and the memory being configured to acquire a vehicle data including position data of each of the multiple vehicles detected by the vehicle position detection unit,
the CPU and the memory being configured to approve among the multiple vehicles a vehicle located within a predetermined range from the patient as an temporary emergency vehicle based on the patient data and the vehicle data when the transportation request is accepted,
the CPU and the memory being configured to output the patient data, a data of the destination medical facility, and a transport instruction of the patient to the destination medical facility to the vehicle side device mounted in the vehicle approved as the temporary emergency vehicle or carried by a user of the vehicle.

6. The emergency transportation arrangement system according to claim 5, wherein
the vehicle side device further has:
a boarding detection unit configured to detect boarding of the patient,
the CPU and the memory are configured to acquire a data of boarding of the patient on the multiple vehicle, and
the CPU and the memory are configured to output the vehicle data of the vehicle approved as the temporary emergency vehicle and a route data from the vehicle having the vehicle data via the patient to the destination medical facility to a traffic system including a traffic control unit for switching traffic signals until boarding of the patient is detected by the boarding detection unit, and to output the vehicle data of a vehicle on which the patient boarded and the route data from the vehicle having the vehicle data to the destination medical facility to the traffic system after boarding of the patient is detected by the boarding detection unit.

7. The emergency transportation arrangement system according to claim 6, wherein
the vehicle side device further has:
a warning unit configured to be able to warn vehicle status externally.

8. The emergency transportation arrangement system according to claim 7, wherein
the warning unit is constituted by a car horn, lights and blinkers.

9. An emergency transportation arrangement method, comprising:
accepting a transportation request from a patient requiring emergency transportation to a medical facility;
acquiring a patient data including a position data of the patient;
determining a destination medical facility to which the patient is to be emergency transported based on the patient data;
registering multiple vehicles allowed in advance by their users to be employed as temporary emergency vehicles for emergency transportation of patients to medical facilities;
acquiring a vehicle data including a position data of the multiple vehicles;
approving among the multiple vehicles a vehicle located within a predetermined range from the patient as an temporary emergency vehicle based on the patient data and the vehicle data when the transportation request is accepted; and
outputting the patient data, a data of the destination medical facility, and a transport instruction of the patient to the destination medical facility, to a vehicle side device mounted in the vehicle approved as the temporary emergency vehicle or carried by a user of the vehicle.
